(19) United States
(12) Patent Application Publication
(10) Pub. No.: US 2021/0286199 A1
(43) Pub. Date: Sep. 16, 2021

(54) CONTACT LENS CLEANER

(71) Applicant: SUZHOU 3N BIOLOGICAL TECHNOLOGY CO., LTD, SIP Suzhou (CN)

(72) Inventor: Bixia SUN, Suzhou city (CN)

(73) Assignee: SUZHOU 3N BIOLOGICAL TECHNOLOGY CO., LTD, SIP Suzhou (CN)

(21) Appl. No.: 16/615,416

(22) PCT Filed: May 2, 2018
(86) PCT No.: PCT/CN2018/085391

§ 371 Date: Nov. 21, 2019

(30) Foreign Application Priority Data
Jun. 6, 2017 (CN) 201720650688.7
Jun. 6, 2017 (CN) 201720650690.4
Jun. 6, 2017 (CN) 201720650797.9

(51) Int. Cl. G02C 13/00; B08B 6/00; B08B 13/00

(52) U.S. Cl. CPC G02C 13/00; B08B 13/00; B08B 6/00

(57) ABSTRACT

The present invention relates to a contact lens cleaning device, and more particularly, relates to a separable contact lens cleaner. The separable contact lens cleaner includes a power supply base (10); a cleaning base (20); and a cleaning mechanism (30). A cleaning receptacle (201) is provided inside the cleaning base (20). The cleaning mechanism (30) includes a power supply assembly (302) and a plurality of electrodes (301) electrically connected to the power supply assembly (302). The power supply assembly (302) is installed inside the power supply base (10). The electrodes (301) are installed in the cleaning receptacle (201). The cleaning base (20) is detachably connected to the power supply base (10). The power supply assembly (302) includes a circuit board (303) and a power supply (304). A plurality of electrode connectors (305) is securely provided at and electrically connected to the circuit board (303). In the contact lens cleaner of the present invention, the cleaning receptacle (201) and the electrodes (301) can be replaced regularly, thereby reducing usage costs, and increasing utilization of an apparatus.

### 1.FIELD OF THE INVENTION

The present invention relates to a contact lens cleaning device, and more particularly to a contact lens cleaner.

### 2. BACKGROUND TECHNIQUE

Quite a few people suffering from myopia choose to use contact lenses for beauty or convenience of movement. However, after long-term use of the contact lens, protein deposits, and the lens loses oxygen permeability, causing a damage to cornea after the contact lens is worn. Therefore, the contact lens must be cleaned for reuse after being worn for a specific period of time.

At present, a most frequently-used manner of cleaning contact lenses is to place the contact lenses into two receptacles of a contact lens cleaning case respectively, and inject cleaning medicinal solution respectively, and then rub the lenses with fingers to remove dust, protein deposits, mucus, and oil stains, etc. on the contact lenses, thereby maintaining oxygen permeability of the lenses. However, in the cleaning manner, it is not likely to achieve a good effect due to unclean fingers, and a cleaning process is quite time-consuming.

At present, there are some commercially available contact lens cleaning devices using ultrasonic wave, a heating-type electromagnetic stirrer, ultraviolet light, or ozone. However, 1) since an ultrasonic frequency for cleaning contact lenses needs to be higher than 100 KHz, the lenses are likely to be damaged physically, and a relatively high matching ability between a circuit and the frequency is required, resulting in relatively high production costs; 2) since the heating-type electromagnetic stirrer performs heating and stirring using an electromagnetic principle, when a cleaning agent is added to separate an attachment from the lenses, it is possible that a user is scalded due to unintended touch and the lenses are damaged at a high heating temperature; 3) although ultraviolet rays have a strong killing effect on bacteria and ozone is a good oxidant and disinfectant, attachments attached to the lens cannot be removed completely.

A utility model patent with Chinese Patent Publication No. CN204964930U discloses a contact lens cleaning device, including a base body, a lens case, a cover body, and a cleaning mechanism. The cover body is closed above the base body and encloses a lens room with the base body. A top face of the base body is provided with a cleaning receptacle for cleaning contact lenses. The lens case includes a case body for storing the contact lenses and a case cover sealed on the case body, the case body being installed on a top of the cleaning receptacle. The base body includes a bottom base and a middle base, the middle base being closed above the bottom base and enclosing an electronic element room with the bottom base. The cleaning mechanism includes a power supply, a circuit board, an electrical conducting sheet, and an electrode. The circuit board is provided inside the electronic element room and is electrically connected to the power supply. There are two electrical conducting sheets both provided inside the electronic element room, and one end of either of the electrical conducting sheets is electrically connected to the circuit board. There are two electrodes respectively provided throughout at bottoms of a left cleaning room and a right cleaning room and connected to the bottom of the cleaning receptacle in a mutually sealed manner. Tops of the electrodes are both exposed inside the cleaning receptacle and bottoms of the electrodes are both exposed in the electronic element room, the bottoms of the electrodes being electrically connected to the other end of the electrical conducting sheet.

However, after such contact lens cleaning device is used for a specific period of time, a contact lens cleaner of the contact lens cleaning device is required to be replaced with a new one, resulting in relatively high usage costs. User experience of the product is also poor. In addition, even if some existing similar products have related detachable structures, it is not convenient to detach such products, and user experience is poor.

Moreover, because a surface of the cleaning receptacle of such contact lens cleaning device does not have a relatively good protective device such as a cleaning receptacle cover, it is difficult to ensure that there is no liquid leakage, and normal use of the contact lens cleaner is also affected.

In view of the foregoing shortcomings, the designer actively makes researches and innovations to create a contact lens cleaner with a new structure, so that the contact lens cleaner is more industrially valuable.

### SUMMARY OF THE INVENTION

In order to resolve one or more of the foregoing technical problems, a first object of the present invention is to provide a contact lens cleaner with one or more detachable cleaning receptacles, of which the cleaning receptacles and electrodes can be regularly replaced, to reduce usage costs, improve user experience, and improve utilization of the apparatus.

In order to resolve one or more of the foregoing technical problems, a second object of the present invention is to provide a separable contact lens cleaner with a stable electrical connection, of which one or more cleaning receptacles and electrodes can be regularly replaced, to reduce usage costs, improve user experience, and improve utilization of the apparatus.

In order to resolve one or more of the foregoing technical problems, a third object of the present invention is to provide a contact lens cleaner that prevents liquid leakage effectively and that is easy to carry and is simple and light to use.

According to one aspect of the present invention, the present invention provides a contact lens cleaner with a detachable cleaning receptacle. The separable contact lens cleaner comprises: a power supply base; a cleaning base detachably connected to the power supply base and provided with one or more cleaning receptacles; and a cleaning mechanism comprising a power supply assembly installed inside the power supply base, and a plurality of electrodes electrically connected to the power supply assembly and installed in the one or more cleaning receptacles. The power supply assembly comprises a circuit board, a power supply, and a plurality of electrode connectors electrically connected to the circuit board, and ends of the electrode connectors are scalable and elastically connected to bottoms of the electrodes respectively.

According to another aspect of the present invention, the present invention provides a contact lens cleaner. The contact lens cleaner comprises: a power supply base; a cleaning base provided with one or more cleaning receptacles; and a cleaning mechanism comprising a power supply assembly installed inside the power supply base, and a plurality of electrodes electrically connected to the power supply assembly and installed in the one or more cleaning receptacles. The cleaning base and the power supply base are respectively provided with a first magnetic connecting member and a second magnetic connecting member that are magnetically attracted to each other, and when the cleaning base is connected to the power supply base through the first magnetic connecting member and the second magnetic connecting member, bottoms of the electrodes in the one or more cleaning receptacle are electrically connected to a plurality of electrode connectors of the power supply assembly respectively.

According to still another aspect of the present invention, the present invention provides a contact lens cleaner. The contact lens cleaner comprises a power supply base; a cleaning base detachably connected to the power supply base and provided with one or more cleaning receptacles; and a cleaning mechanism comprising a power supply assembly installed inside the power supply base, and a plurality of electrodes electrically connected to the power supply assembly and installed in the one or more cleaning receptacles. A cleaning receptacle cover being made of an elastomeric material for sealing the one or more cleaning receptacles is provided on a top of the one or more cleaning receptacle.

In the foregoing solutions, various implementations of the present invention have one or more of the following advantages: 1) providing a scalable elastic electrode connector on an end of the power supply base can not only provide a detachable connection, but also ensure stability and accuracy of an electrical connection; 2) in a design in which the elastic electrode connector is directly provided on a circuit board and is in elastic contact with and connected to an electrode, production, installation, and maintenance of the product are more simplified, thereby facilitating reduction of costs and improvement of efficiency; 3) a detachable connection structure using a magnetic adsorption manner enhances user experience greatly, in that a cleaning base may be taken out and installed repeatedly, and the cleaning base is used alone as a contact lens case for storing contact lens, facilitating carrying and enriching use functions; 4) when the electrode is aged as a result of being repeatedly used for a specific number of times after electrified, an old cleaning base may be replaced with a new one, so that utilization of repeated use of the power supply base is improved, or multiple cleaning bases may share one power supply base, to save resources and protect the environment; 5) the electrode connector is connected to a connector through hole through tolerance interference fit sealing or hot melt sealing, so that a waterproof effect can be effectively improved; 6) a soft cleaning receptacle cover and a top of the hard cleaning receptacle can achieve effective sealing to prevent leakage, and are light and convenient to use; and 7) a soft cleaning receptacle cover made of silica gel or rubber has a specific height, and when an outer cover is closed, the cleaning receptacle cover and the outer cover can form compressed interference fit, further strengthening a sealing effect, so that liquid leakage performance of the entire product is further improved.

The foregoing descriptions are merely brief descriptions of the technical solutions in the present invention. To more clearly understand the technical means of the present invention, and implement based on the content of the specification, the following uses preferred embodiments of the present invention for detailed descriptions with reference to the accompanying drawings.

### BRIEF DESCRIPTION OF THE DRAWINGS

The drawings described herein are provided to further understand the present application, and are intended to be a part of this application. In the drawing:

FIG. 1 is a perspective view of a contact lens cleaner according to the present invention;

FIG. 2 is a cross-sectional view along a line A-A in FIG. 1;

FIG. 3 is a perspective view of a cleaning base according to the present invention;

FIG. 4 is a perspective view of a bottom base of the cleaning base according to the present invention;

FIG. 5 is a perspective view of a lower cover of the bottom base of the cleaning base according to the present invention;

FIG. 6 is a top perspective view of a power supply base according to the present invention;

FIG. 7 is a bottom perspective view of the power supply base according to the present invention;

FIG. 8 is a bottom perspective view of an upper housing of the power supply base according to the present invention;

FIG. 9 is a top perspective view of a lower housing of the power supply base according to the present invention;

FIG. 10 is a top perspective view of a battery cover according to the present invention; and

FIG. 11 is a perspective view of a power supply assembly according to the present invention.

### DETAILED DESCRIPTION OF THE INVENTION

In order to make the schemes and advantages of the embodiments of the present invention clearer, the exemplary embodiments of the present invention are further described in detail with reference to the accompanying drawings. Obviously, the described embodiments are only part of the embodiments of the present invention, and not all exhaustive embodiments. It should be noted that the embodiments of the present invention and the features of the embodiments may be combined with each other in case of no conflict.

Specific implementations of the present invention are further described in detail below with reference to the accompanying drawings and embodiments. The following embodiments are intended to describe the present invention, but are not intended to limit the scope of the present invention. For understanding easily, the main components are listed below with their corresponding reference numerals: a power supply base 10; a second magnetic connecting member 101; grooves 102; a positioning member 103; connector through holes 104; an upper housing 105 of the power supply base; a lower housing 106 of the power supply base; a battery cover 107; a slot 108; a fixture block 109; a cleaning base 20; cleaning receptacles 201; a first magnetic connecting member 202; accessories 203; a bottom base 204 of the cleaning base; an outer cover 205; a cleaning receptacle cover 206; a cleaning mechanism 30; electrodes 301; a power supply assembly 302; a circuit board 303; a power supply 304; and electrode connectors 305. First Embodiment

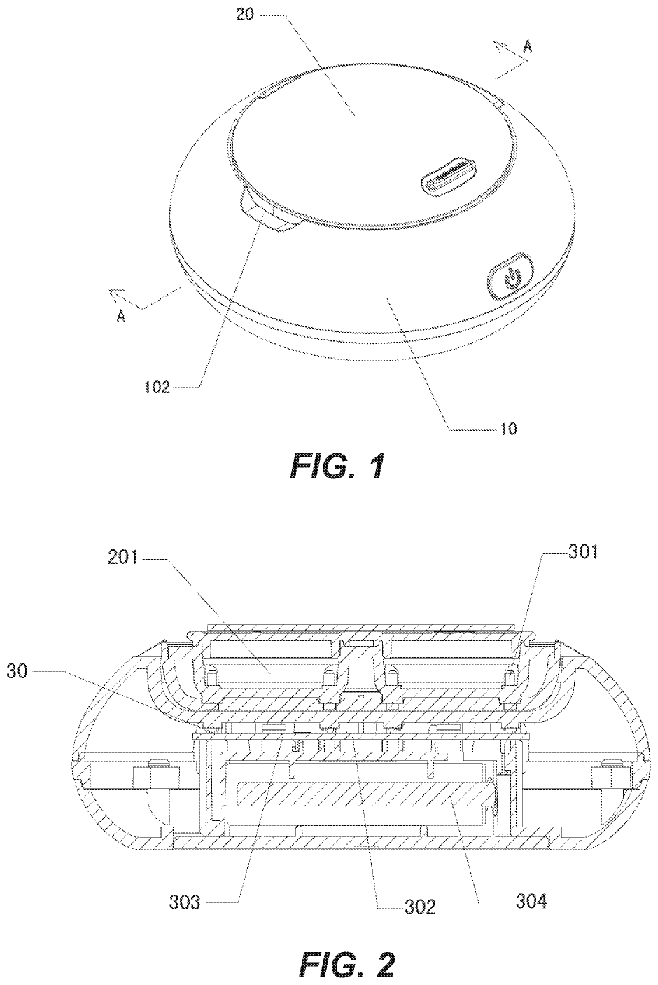

As shown in FIG. 1 and FIG. 2, a contact lens cleaner is provided according to a first embodiment of the present invention. The contact lens cleaner includes a power supply base 10, a cleaning base 20 and a cleaning mechanism 30. Two cleaning receptacles 201 are arranged inside the cleaning base 20. The cleaning mechanism 30 includes a power supply assembly 302 and a plurality of electrodes 301 electrically connected to the power supply assembly 302. The power supply assembly 302 is installed inside the power supply base 10. The electrodes 301 are installed in the cleaning receptacles 201. The cleaning base 20 is detachably connected to the power supply base 10.

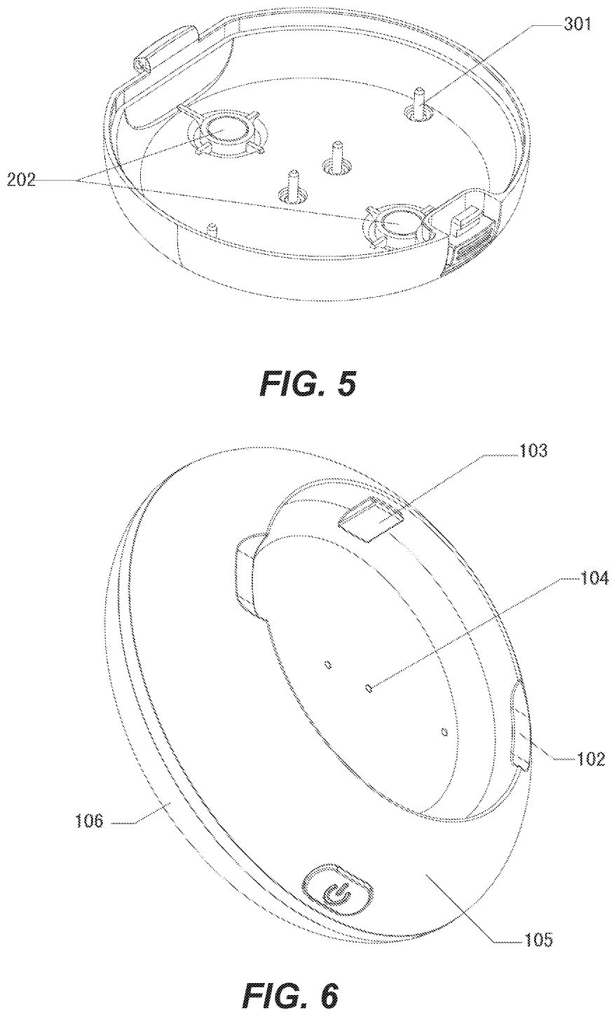

It should be noted that the cleaning base 20 may be detachably connected to the power supply base 10 in various manners, such as fitting of a snap and a slot, or connecting both through a fixing connector such as a screw or a positioning rod. The present invention provides a preferred implementation. As shown in FIG. 5 and FIG. 8, the cleaning base 20 and the power supply base 10 are respectively provided with a first magnetic connecting member 202 and a second magnetic connecting member 101 that are magnetically attracted to each other. Both the first magnetic connecting member 202 and the second magnetic connecting member 101 are magnetic members, or one is a magnetic member and the other is a metal member that is attracted to the magnetic member. The magnetic member is made of neodymium iron boron, silicon steel, an amorphous material, nanocrystalline, ferrite, or a magnetic powder core. The metal member is made of iron, nickel, cobalt, or some alloys thereof. For example, the first magnetic connecting member 202 inside the cleaning base 20 is provided as a metal member, and the second magnetic connecting member 101 inside the power supply base 10 is provided as a magnetic member. Since the cleaning base 20 may be detachably replaced, replacing costs can be reduced.

A connection through magnetic attraction set for the cleaning base 20 has the following advantages: 1) wear caused in a hard connection manner such as a snap between the cleaning base 20 and the power supply base 10 is avoided; 2) it is convenient to perform taking and placing, so that the cleaning base 20 may be taken out and replaced without much effort; 3) the cleaning base 20 may be taken out and installed repeatedly, and the cleaning base 20 is used alone as a contact lens case for storing contact lens, facilitating carrying and enriching use functions; 4) because bottoms of the electrodes 301 needs to be electrically connected to the power supply assembly 302, a connection through magnetic attraction can effectively prevent a damage to the electrodes 301 during installation; 5) when the electrodes are aged as a result of being repeatedly used for a specific number of times after electrified, an old cleaning base may be replaced with a new one, so that utilization of repeated use of the power supply base 10 is improved and resources are saved.

It should be further noted that positions for installing the cleaning base 20 and the power supply base 10 are not limited, and the cleaning base 20 may be provided on a top of the power supply base 10. In order to improve stability and accuracy of a connection, a cleaning base installation slot may be further provided on the top of the power supply base 10, and the cleaning base 20 is received in the cleaning base installation slot. Alternatively, the cleaning base 20 may be provided on a side face of the power supply base 10, in order to improve the stability of the connection, a cleaning base installation slot or a positioning member may be further provided on the side face of the power supply base 10.

When the cleaning base 20 is installed on the top of the power supply base 10, a pair of grooves 102 is further provided on both sides of the cleaning base installation slot on the top of the power supply base 10 to facilitate installation and detaching of the cleaning base 20, so that fingers can be inserted to dig out the cleaning base 20 during detaching. In order to accurately determine the position for installing the cleaning base 10, as shown in FIG. 6, a positioning member 103 is further provided inside the cleaning base installation slot on the top of the power supply base 10, and a guiding member fitting the positioning member is correspondingly provided on the cleaning base 20. Simply speaking, the positioning member 103 is a protruding positioning rod, and the guiding member is a guiding groove or a tangent plane provided on a side face of the cleaning base 10.

The cleaning base 20 is an area for operating the contact lens cleaner, in which accessories 203 such as a tweezer, a contact lens stick bar, and a mirror, etc. may also be placed.

A working principle of the present invention is based on electrophoresis technologies, that is, a charged particle moves toward an electrode with an electrical property opposite to that of the particle under action of an electric field, which is referred to as electrophoresis (EP). Protein is a molecule that has complete biological activity and that is formed by one or more polypeptide chains in respective special combination manners. Protein is an ampholyte. When being at an isoelectric point, a protein molecule has a zero static charge, and is generally positively charged in a slightly acidic solution and negatively charged in a slightly alkaline solution. When the electrodes are electrified, since the power supply assembly 302, the electrodes 301, and a care solution form an electrical path. Because a specific potential difference is applied between two electrodes, protein attached to the contact lens is detached from the contact lens due to an action of the potential difference, moves toward one of the electrodes in the care solution, and is finally absorbed on a surface of the electrode, thereby cleaning the contact lens and restoring a good use state of the contact lens.

In order to tightly connect the electrodes 301 and the cleaning base 20 to prevent the care solution from being leaked from a joint, an outer surface of each electrode is provided with a rough face, and each electrode is integrally formed with the cleaning base 20. The rough face may be implemented in various manners. For example, the rough face may be formed through providing of lines on the surface of the electrode, sandblasting, or plating of one or more layers. The electrodes with the rough face are integrally formed in the cleaning base through injection molding. In this way, the cylindrical electrodes can be prevented from rotating, shaking, moving up and down, and having a gap, etc., thereby preventing liquid leakage at an electrode position inside the cleaning base 20.

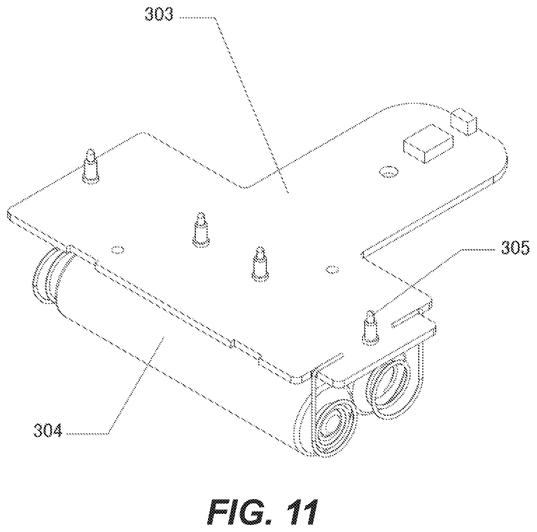

It should be noted that, as shown in FIG. 2 and FIG. 11, the power supply assembly 302 includes a circuit board 303 and a power supply 304, as well as a plurality of electrode connectors 305 provided above the power supply assembly 302. The power supply 304 is configured to supply power for the circuit board 303. The power supply that can achieve such function shall fall into the protection scope, and different structures varying according to the different power supplies shall also fall into the protection scope of the present invention. A built-in dry battery, a rechargeable lithium battery, a button battery, or an external power connector can be selected as the power supply 304. The circuit board 303 is configured to adjust a specific potential difference, a magnitude of a current, and a time of electrification between the two electrodes 301. Any circuit board that can achieve this function should fall within the protection scope of the contact lens cleaner of the present invention. Adjustment of the potential difference, the current magnitude, and the electrification time are not limited to complexity of electronic elements such as a resistor, a capacitor, a chip, or an integrated circuit, or to whether there is control of a computer software program.

### Second Embodiment

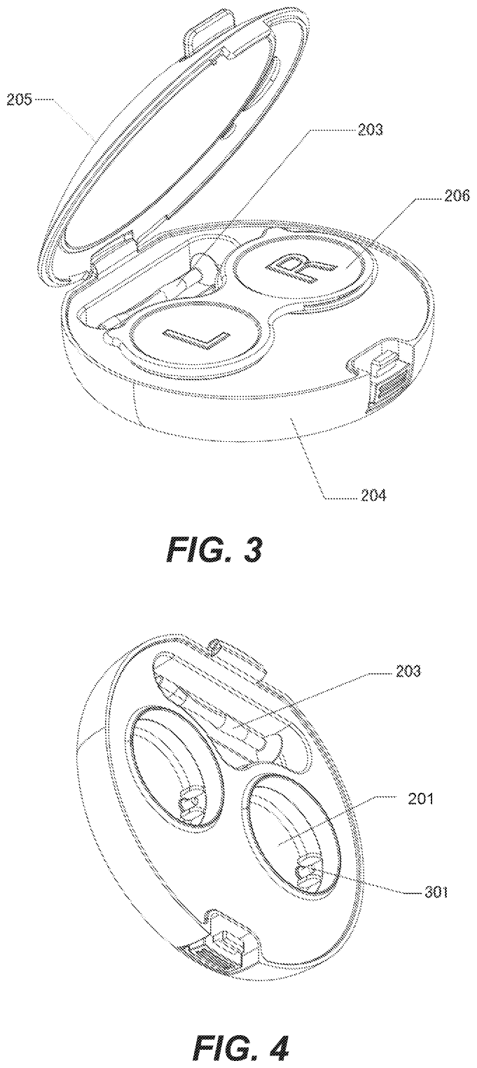

As shown in FIG. 3, FIG. 4, and FIG. 5, the cleaning base 20 includes a bottom base 204 of the cleaning base 20, an outer cover 205, and a cleaning receptacle cover 206. A top of the cleaning base 20 is provided with two cleaning receptacles 201. There are two pairs of electrodes 301 respectively provided on two sides of the two cleaning receptacles 201. The cleaning receptacle cover 206 is sealed on a top of the cleaning receptacle 201, and the outer cover 205 is closed on a top of the bottom base 204 of the cleaning base 20. It should be noted that one cleaning receptacle 201 may be provided, and the cleaning receptacle 201 may be divided into a left cleaning room and a right cleaning room that are connected to each other. One pair of electrodes is respectively provided on both sides of the cleaning receptacle 201. A difference is that in a design of two cleaning receptacles, cross contamination of the contact lenses is avoided during cleaning. A lifting handle may also be provided on the outer cover 205 to facilitate closing of the outer cover.

The electrodes 301 are provided throughout the cleaning receptacle 201, and bottoms of the electrodes 301 is not exposed at the bottom of the cleaning base 20, to prevent a damage to the electrodes when the cleaning base is carried alone for use. The circuit board 303 is provided inside the power supply base 10, and the electrode connectors 305 is securely provided at the circuit board 303. Ends of the electrode connectors are scalable to be elastically connected to the bottoms of the electrodes 301. A plurality of connector through holes 104 is provided on the power supply base 10, and the electrode connectors 305 are provided through the connector through holes 104 respectively. When the cleaning base 20 is installed on the power supply base 10, the bottoms of the electrodes are electrically connected to the circuit board 303 through the elastic electrode connectors 305. In this way, the electrodes 301 is stably connected to the circuit board 303, and a damage caused to the electrodes is effectively avoided during installation of the cleaning base 20 on the power supply base 10. The connector through holes 104 are provided on the power supply base 10, and the electrode connectors 305 and the connector through holes 104 are connected through tolerance interference fit sealing or hot melt sealing, so that a waterproof effect is improved.

### Third Embodiment

The first embodiment and the second embodiment of the present invention provide a contact lens cleaner whose cleaning base may be carried alone for use. The cleaning base 20 includes a bottom base 204 of the cleaning base, an outer cover 205, and a cleaning receptacle cover 206. Two cleaning receptacles 201 are provided on a top of the cleaning base 20. The cleaning receptacle cover 206 is sealed on tops of the two cleaning receptacles 201. The cleaning receptacle cover 206 is made of a macromolecule elastomeric material. The soft cleaning receptacle cover 206 and a top of the hard cleaning receptacle 201 can achieve effective sealing to prevent leakage, and is light and convenient to use.

The macromolecule elastomeric material includes a thermoplastic polyurethane elastomer material, a thermoplastic polyvinyl chloride elastomer material, a thermoplastic polyolefin elastomer material, a styrene or butadiene copolymer elastomer material, or a silica gel elastomer material. Preferably, the cleaning receptacle cover 206 is a silica gel cleaning receptacle cover. Compressed interference fit between the soft cleaning receptacle cover 206 and the outer cover 205 further strengthens the sealing effect, thereby further improving leakage prevention performance of the entire product.

In order to prevent the cleaning receptacle cover 206 from being lost due to being randomly placed, one end of the cleaning receptacle cover may be further connected to the cleaning base 20. A connection manner includes, but is not limited to, being adhered to each other, hitching the cleaning receptacle cover to a protruding portion of the cleaning base, or providing a protruding portion on one end of the cleaning receptacle cover and inserting the protruding portion into an installation hole of the cleaning base.

The cleaning receptacle cover 206 includes a left cover body and a right cover body integrally formed and connected to each other, and the left cover body and the right cover body are respectively sealed on the two cleaning receptacles.

### Fourth Embodiment

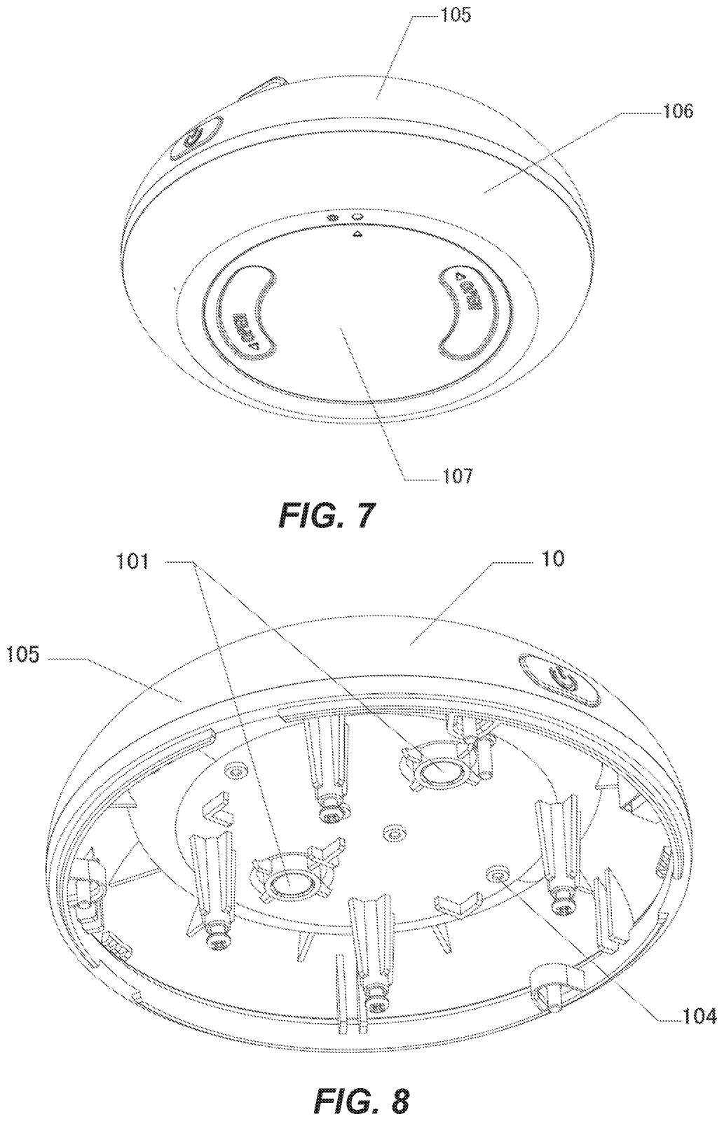

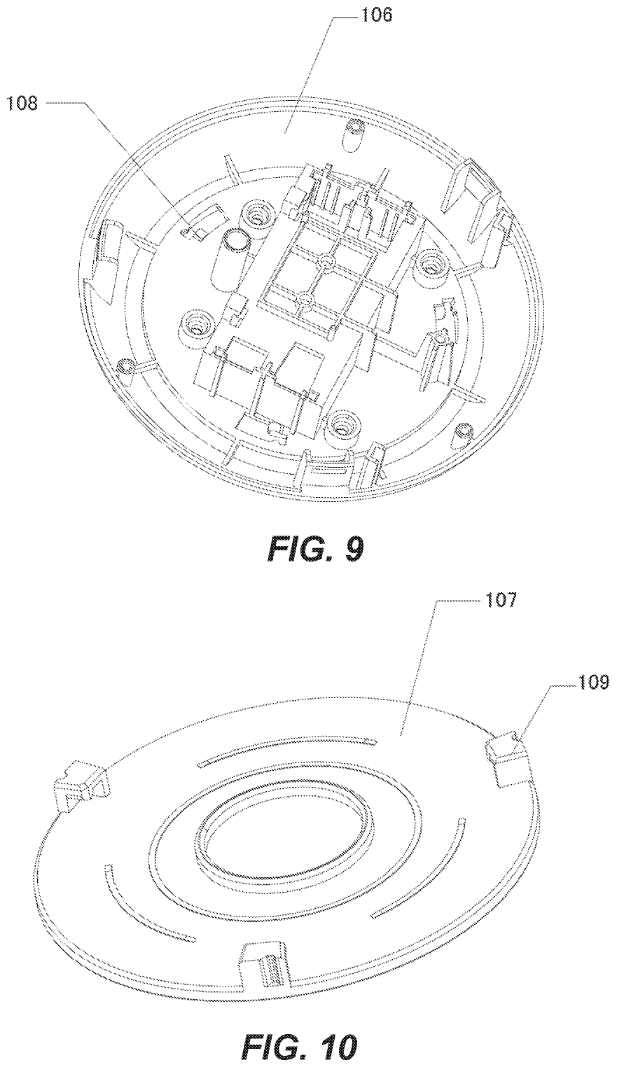

The first embodiment and the second embodiment of the present invention provide a contact lens cleaner whose cleaning base may be carried alone for use. As shown in FIG. 7 to FIG. 10, the power supply base 10 includes an upper housing 105 of the power supply base 10, a lower housing 106 of the power supply base 10, and a battery cover 107. The upper housing 105 of the power supply base and the lower housing 106 of the power supply base are closed mutually to form a power supply room. The circuit board 303 is provided in the power supply room. A battery slot is provided at a bottom of the lower housing of the power supply base, and the battery cover 107 is closed on the battery slot.

It should be noted that the battery cover 107 and the battery slot may be closed in various manners, including using a snap or magnetic absorption. In this embodiment, a preferred manner is provided, in which a manner of fastening through rotating is used. The battery cover 107 is a circular-plate shape, multiple slots 108 are provided on the lower housing of the power supply base, and multiple fixture blocks 109 are provided on the battery cover. The battery cover 107 is fastened to the battery slot, and the fixture block and the slot are fastened and fixed to each other after rotating.

The foregoing descriptions are merely preferred implementations of the present invention and are not intended to limit the present invention. It should be noted that a person of ordinary skill in the art may make several improvements or variations without departing from the technical principle of the present invention and the improvements or variations shall fall within the protection scope of the present invention.

Obviously, a person skilled in the art may make various changes and variations to the application without departing from the spirit and scope of the application. Thus, if these modifications and variations of this application fall within the scope of the claims and their equivalent technologies, the application is also intended to include these changes and variations.

I claim:

1. A separable contact lens cleaner, comprising:
a power supply base;
a cleaning base detachably connected to the power supply base and provided with one or more cleaning receptacles; and
a cleaning mechanism comprising a power supply assembly installed inside the power supply base, and a plurality of electrodes electrically connected to the power supply assembly and installed in the one or more cleaning receptacles;
wherein the power supply assembly comprises a circuit board, a power supply, and a plurality of electrode connectors electrically connected to the circuit board, and ends of the electrode connectors are scalable and elastically connected to bottoms of the electrodes respectively.

2. The separable contact lens cleaner according to claim 1, wherein the electrode connectors are directly fixed on the circuit board, and the electrode connectors are elastically connected to the bottoms of the electrodes through a plurality of connector through holes on the power supply base respectively.

3. The separable contact lens cleaner according to claim 1, wherein the cleaning base is detachably connected to the power supply base through mutual fitting of a snap and a slot, a magnetic connection, or installation using a fixed connecting member.

4. The separable contact lens cleaner according to claim 3, wherein the cleaning base and the power supply base are respectively provided with a first magnetic connecting member and a second magnetic connecting member that are magnetically attracted to each other, and wherein both the first magnetic connecting member and the second magnetic connecting member are magnetic members, or one is a magnetic member and the other is a metal member that is attracted to the magnetic member.

5. The separable contact lens cleaner according to claim 1, wherein a cleaning receptacle cover being made of a macromolecule elastomeric material is provided on a top of the one or more cleaning receptacles, and wherein two cleaning receptacles are provided on a top of the cleaning base, the cleaning receptacle cover comprise a left cover body and a right cover body that are integrally formed and connected to each other, and the left cover body and the right cover body are sealed on the two cleaning receptacles respectively.

6. The separable contact lens cleaner according to claim 1, wherein a cleaning base installation slot is provided on a top of the power supply base, and the cleaning base is detachably received in the cleaning base installation slot.

7. The separable contact lens cleaner according to claim 6, wherein a pair of grooves is further provided on both sides of the cleaning base installation slot.

8. The separable contact lens cleaner according to claim 6, wherein a positioning member is further provided inside the cleaning base installation slot, and a guiding member fitting the positioning member is correspondingly provided on the cleaning base, and wherein the positioning member is a protruding positioning rod, and the guiding member is a guiding groove or a tangent plane provided on a side face of the cleaning base.

9. The separable contact lens cleaner according to claim 1, wherein a plurality of connector through holes is provided on the power supply base, the electrode connectors and the connector through holes are connected through tolerance interference fit sealing or hot melt sealing.

10. A contact lens cleaner, comprising:
a power supply base;
a cleaning base provided with one or more cleaning receptacles; and
a cleaning mechanism comprising a power supply assembly installed inside the power supply base, and a plurality of electrodes electrically connected to the power supply assembly and installed in the one or more cleaning receptacles;
wherein the cleaning base and the power supply base are respectively provided with a first magnetic connecting member and a second magnetic connecting member that are magnetically attracted to each other, and when the cleaning base is connected to the power supply base through the first magnetic connecting member and the second magnetic connecting member, bottoms of the electrodes in the one or more cleaning receptacle are electrically connected to a plurality of electrode connectors of the power supply assembly respectively.

11. The contact lens cleaner according to claim 10, wherein both the first magnetic connecting member and the second magnetic connecting member are magnetic members, or one is a magnetic member and the other is a metal member that is attracted to the magnetic member.

12. The contact lens cleaner according to claim 10, wherein the plurality of electrode connector is provided on a circuit board of the power supply assembly, and ends of the electrode connectors are scalable and elastically connected to the bottoms of the electrodes through the power supply base.

13. The contact lens cleaner according to claim 10, wherein a cleaning base installation slot is provided on a top of the power supply base, and the cleaning base is detachably received in the cleaning base installation slot.

14. The contact lens cleaner according to claim 13, wherein a pair of grooves is further provided on both sides of the cleaning base installation slot.

15. The contact lens cleaner according to claim 13, wherein a positioning member is further provided inside the cleaning base installation slot, and a guiding member fitting the positioning member is correspondingly provided on the cleaning base.

16. The contact lens cleaner according to claim 15, wherein the positioning member is a protruding positioning rod, and the guiding member is a guiding groove or a tangent plane provided on a side face of the cleaning base.

17. The contact lens cleaner according to claim 10, wherein a soft snap-fit cleaning receptacle cover is provided on the one or more cleaning receptacle, and the cleaning base is provided with an outer cover.

18. A contact lens cleaner, comprising:
a power supply base;
a cleaning base detachably connected to the power supply base and provided with one or more cleaning receptacles; and
a cleaning mechanism comprising a power supply assembly installed inside the power supply base, and a plurality of electrodes electrically connected to the power supply assembly and installed in the one or more cleaning receptacles;
wherein a cleaning receptacle cover being made of an elastomeric material is provided on a top of the one or more cleaning receptacle to seal the one or more cleaning receptacle.

19. The contact lens cleaner according to claim 18, wherein the cleaning receptacle cover is made of thermoplastic polyurethane elastomer material, a thermoplastic polyvinyl chloride elastomer material, a thermoplastic polyolefin elastomer material, a styrene or butadiene copolymer elastomer material, or a silica gel elastomer material, or the cleaning receptacle cover is a silica gel cleaning receptacle cover.

20. The contact lens cleaner according to claim 19, wherein the cleaning base is provided with an outer cover, and the outer cover can compress the cleaning receptacle cover through interference fit when closed.

21. The contact lens cleaner according to claim 18, wherein one end of the cleaning receptacle cover is connected to the cleaning base in one manner of being adhered to each other, being hitched to a protruding portion of the cleaning base, and being inserted into an installation hole on the cleaning base.

22. The contact lens cleaner according to claim 18, wherein two cleaning receptacles are provided on a top of the cleaning base, the cleaning receptacle cover comprise a left cover body and a right cover body that are integrally formed and connected to each other, and the left cover body and the right cover body are sealed on the two cleaning receptacles respectively.

23. The contact lens cleaner according to claim 18, wherein the cleaning base is detachably connected to the power supply base through mutual fitting of a snap with a slot, a magnetic connection, or installation using a fixed connecting member.

24. The contact lens cleaner according to claim 18, wherein a cleaning base installation slot is provided on a top of the power supply base, and the cleaning base is detachably received in the cleaning base installation slot.

25. The contact lens cleaner according to claim 24, wherein a pair of grooves is further provided on both sides of the cleaning base installation slot.

26. The contact lens cleaner according to claim 24, wherein a positioning member is further provided inside the cleaning base installation slot, and a guiding member fitting the positioning member is correspondingly provided on the cleaning base, and wherein the positioning member is a protruding positioning rod, and the guiding member is a guiding groove or a tangent plane provided on a side face of the cleaning base.
